(19) United States
(12) Patent Application Publication
(10) Pub. No.: US 2025/0153072 A1
(43) Pub. Date: May 15, 2025

(54) COLLECTION SYSTEM FOR THE RECOVERY OF A SEPARATED RADIOACTIVE FRACTION

(71) Applicant: OUT AND OUT CHEMISTRY, Neuville (BE)

(72) Inventors: Yoann JOYARD, Lyon (FR); Nicolas MAINDRON, Venissieux (FR); Vincent TADINO, Chastres (BE)

(73) Assignee: OUT AND OUT CHEMISTRY, Neuville (BE)

(21) Appl. No.: 18/840,774

(22) PCT Filed: Feb. 20, 2023
(86) PCT No.: PCT/EP2023/054208

§ 371 Date: Aug. 22, 2024

(30) Foreign Application Priority Data
Feb. 24, 2022 (BE) BE2022/5130

(51) Int. Cl. B01D 15/10; B01D 15/40; G01T 7/02

(52) U.S. Cl. CPC B01D 15/102; B01D 15/40; G01T 7/02

(57) ABSTRACT

A collection system for recovering a separated radioactive fraction, comprising: a collection inlet configured to receive a fraction from a separation system, a radio detector configured to determine the radioactivity of the fraction and generate a radiodetection signal based on the determined radioactivity, a collection valve system in fluid communication with the collection inlet, wherein the collection valve system comprises at least one or more of the collection vessel outlets and a waste outlet, a control unit configured to control the collection valve system to guide the fraction to one of the collection vessel outlets or a waste outlet.

This invention relates to the field of separation of radioactive fractions, for example for use as a radioactive or radiopharmaceutical marker, for example in positron emission tomography (PET).

Several systems are known for producing radioactive labels or radiopharmaceuticals in general. In general, the radioactive substance is first produced in a reaction, resulting in a sample having several substances including said radioactive substance. To isolate the radioactive substance, the sample can be subjected to a separation process wherein the radioactive substance is isolated. The isolated radioactive substance is then reformulated into a solution that can be injected into a human or animal.

Since a radiopharmaceutical is radioactive and is characterised by an often relatively short “half-life”, time is an important factor when producing such a product.

At the same time, hygiene and quality must meet very strict requirements in the pharmaceutical industry.

Therefore, one object of the invention is to provide a system and/or a method allowing for a faster production of radiopharmaceutical products, and/or a higher quality, and/or at least to provide an alternative to the prior art.

This object is achieved with a collection system for recovering a separated radioactive fraction, comprising:
a collection inlet configured to receive a fraction from a separation system,
a radio detector configured to determine the radioactivity of the fraction and to generate a radiodetection signal based on the determined radioactivity,
a collection valve system in fluid communication with the collection inlet, wherein the collection valve system comprises at least one or more outlets to a collection vessel and a waste outlet,
a control unit configured to control the collection valve system to guide the fraction to one of the outlets to a collection vessel or to the waste outlet.

The invention therefore relates to a collection system. The collection system can be used to recover a separated radioactive fraction. In this context, “separated” means that the radioactive fraction is a separated fraction of a sample comprising a plurality of substances. At least one of said substances present in the sample is a radioactive substance. The radioactive fraction comprises a high level of the radioactive substance. It will be understood, however, that in practice it is possible that the radioactive fraction may not consist of 100% of the radioactive substance, i.e. the radioactive fraction can comprise substances other than the radioactive substance. These other substances can, for example, include a non-radioactive substance and/or another radioactive substance. The radioactive fraction can for example comprise a mobile phase.

For example, the radioactivity ratio from the radioactive substance in the fraction, also defined as radiochemical purity, can be at least 80%, for example at least 85%, for example at least 90%, for example at least 95%, for example at least 99%.

The radioactive substance can for example be an organic molecule, such as glucose or an amino acid, carrying a radioisotope such as carbon-11, fluorine-18, iodine-131. The radioactive substance can for example be a peptide, for example a small peptide. The radioactive substance can for example be aromatic or polyaromatic.

According to the invention, the collection system for recovering a separated radioactive fraction comprises:
a collection inlet configured to receive a fraction from a separation system,
a radio detector configured to determine the radioactivity of the fraction and to generate a radiodetection signal based on the determined radioactivity,
a collection valve system in fluid communication with the collection inlet, wherein the collection valve system comprises at least one or more outlets to a collection vessel and a waste outlet,
a control unit configured to control the collection valve system to guide the fraction to one of the outlets to a collection vessel or to the waste outlet.

The collection system comprises a collection inlet. Via the collection inlet, a fraction can be received from a separation system. The separation system can for example be a chromatography system, for example a supercritical fluid chromatography system or a high-performance liquid chromatography system. The separation system can for example be configured to separate the fraction of a sample comprising a plurality of substances. The separation system can for example be a purification system. The collection inlet can for example be a pipe portion in fluid communication with an outlet of the separation system, wherein additional components are optionally provided between said outlet and the collection inlet.

The collection system further comprises a radio detector. The fraction can be subjected to measurement by the radio detector to determine the radioactivity of the fraction. Based on this measurement, a radiodetection signal can be generated by the radio detector. The radio detector can be any of the known types of radioactivity detection or measurement devices, for example a semiconductor detector such as a PIN diode radiation detector.

The collection system further comprises a collection valve system. The collection valve system can comprise one or more valves that can be fluidly connected to each other. Said valve can for example be a 4-port, 6-port or 8-port valve. Said valve can for example be a switching valve. The collection valve system is in fluid communication with the collection inlet, thereby transferring the fraction from the collection inlet to the collection valve system. Optionally, one or more components are arranged between the collection inlet and the collection valve system.

The collection valve system comprises a plurality of outlets, including at least one waste outlet. The waste outlet can for example be used when the fraction from the collection valve cannot be used, for example because it does not contain sufficient radioactive substance or because it has been used to clean the collection system. The collection valve system also comprises at least one outlet to a collection vessel. The outlet to a collection vessel can be configured to be in fluid communication with a collection vessel. The collection vessel can for example be configured to receive the fraction when it meets certain requirements, for example with respect to composition and/or radioactivity. More than one collection vessel outlet can for example be desirable when the separation system is configured to provide several mutually different fractions, which are to be stored separately in different collection vessels. This can for example be of interest for R&D purposes. In production applications, having several collection vessels can also have safety advantages in situations where the collection of a fraction in a collection vessel is started at the wrong time. It is also possible that the radioactive fraction is provided by the separation system in relatively large quantities, so that more than one collection vessel needs to be provided with the radioactive fraction.

The collection system further comprises a control unit configured to control the collection valve system. By controlling the collection valve system, the control unit can control which outlet the fraction is guided to. It can therefore be ensured that the fraction is guided to a collection vessel when the radioactivity determined by the radio detector is desirable, and to waste disposal if not.

In some embodiments, the control unit is configured to receive the radiodetection signal from the radio detector and control the collection valve system based on the radiodetection signal. Based on the detection signal, the control unit can determine whether the fraction comprises sufficient radioactive substance. In this case, the fraction is guided to the appropriate collection vessel outlet, and if not, the fraction can for example be guided to the waste outlet. Therefore, in these embodiments, the collection system is automated.

In some embodiments, the collection system further comprises an operator interaction system configured to: receive the radiodetection signal and generate an operator output based on the radiodetection signal; receive an operator input and generate an operator control signal based on the operator input. The control unit can be configured to control the collection valve system based on the operator control signal.

In these embodiments, an operator can control the collection system using the operator interaction system. The operator output generated based on the radiodetection signal can be configured to inform the operator of the radioactivity determined by the radio detector. For example, the operator interaction system can comprise a display configured to display the operator output to the operator. If the operator determines from the operator output that the radioactivity meets the desired specifications, the operator interaction system can provide an operator input. The operator interaction system can, for example, comprise a keypad, touchscreen, button, or the like for receiving operator input from the operator. The operator input is translated into an operator control signal, based on which the control unit controls the collection valve system, in such a way that the fraction is guided as desired by the operator. Optionally, the control unit is also configured to control the operator interaction system.

The control unit can, for example, comprise one or more input terminals, output terminals, or communication terminals configured to communicate with one or more input terminals, output terminals, or communication terminals of other components such as the radio detector, the operator interaction system, or the collection valve system. Such communication can correspond to any of the known suitable communication methods or protocols, including wired or wireless communication. The control unit can, for example, be or comprise a processing unit. The control unit can, for example, comprise memory for storing the received signals and/or computer-readable instructions. The control unit can, for example, be implemented in a PLC, a computer, or a user device such as a smartphone or tablet.

In some embodiments, the separation system is a supercritical fluid chromatography system. Supercritical fluid chromatography (SFC) allows for a rapid separation process, which is beneficial given the relatively short half-lives of radioactive substances used for the envisaged radiopharmaceuticals. The separation system can, for example, be configured to use a mobile phase to dissolve the radioactive substance. The mobile phase can for example be a supercritical fluid, for example a compressed gas near, around or above its critical temperature and pressure, such as carbon dioxide or nitrous oxide. Carbon dioxide is preferred. The mobile phase can also comprise a modifier, for example to modify the polarity or strength of the supercritical fluid. The modifier can for example be methanol or ethanol. In particular, the use of ethanol as a modifier can be advantageous, as it can reduce the time required for reformulation, since the fraction should now only be diluted with a biocompatible aqueous solution.

In some embodiments, the collection system comprises a back pressure regulator between the separation system and the collection valve system. The back pressure regulator can be configured to maintain an upstream pressure located upstream of the back pressure regulator, wherein the upstream pressure is greater than a downstream pressure located downstream of the back pressure regulator. Especially when SFC-type chromatography is used, the pressure in the separation system will be high and must be kept high, for example at least 70 bar or at least 80 bar. Downstream of the back pressure regulator, the pressure can be lowered, which can cause rapid decompression of the mobile phase. For example, a supercritical fluid component, e.g. carbon dioxide, of the mobile phase can convert to the gaseous state while the modifier remains in the liquid phase. Optionally, the back pressure regulator is arranged downstream of the radio detector and upstream of the collection valve system. Therefore, the radio detector is configured to determine the radioactivity of the high-pressure fraction.

In some embodiments, the collection system comprises a gas/liquid separation unit, wherein the gas/liquid separation unit is configured to separate gas from fluid in the fraction, optionally after leaving the collection valve system, for example upon entering one of the collection vessels. This embodiment can be particularly advantageous when using SFC-type chromatography, since the mobile phase can be partially converted to the gaseous state after decompression. The gas/liquid separation unit can be used to make the remaining fraction more concentrated, since a gaseous portion of the mobile phase can be removed. This can also reduce the time required for reformulation, particularly if the radioactive substance is dissolved in the modifier only, for example when the modifier is ethanol.

In some embodiments, the gas/liquid separation unit is a cyclone. The use of a cyclone can be advantageous in particular because it allows the gas and liquid to be separated at atmospheric pressures. The cyclone can for example be arranged at the outlet of the collection vessel of the collection valve system or at the inlet of a collection vessel. In embodiments wherein the collection system comprises a plurality of collection vessel outlets and/or a plurality of collection valves, it is possible for the collection system to comprise a corresponding plurality of cyclones.

In some embodiments, the collection system further comprises at least a first collection vessel configured to be in fluid communication with the first outlet to a collection vessel of the collection valve system. The collection vessel can advantageously be used to collect the fraction. Optionally, the first collection vessel comprises a cap composed of PEEK, polypropylene, PTFE or stainless steel.

In some embodiments, the collection system further comprises a detection enhancer for the radio detector. The detection enhancer can be configured to enhance the determination of radioactivity by the radio detector. For example, the detection enhancer can be a stainless steel loop. The stainless steel loop can be arranged in front of the radio detector to enhance the sensitivity of the radio detector.

In some embodiments, the collection system further comprises a UV detector configured to determine the UV value of the fraction and to generate a UV detection signal based on the determined UV value. For example, the UV value can represent the amount of ultraviolet or visible light absorbed by the fraction. Determining the UV value identifies a property of the fraction in addition to the radioactivity determined with the radio detector. This allows the content of the fraction, i.e., which substances it comprises and/or in what quantity, to be determined more accurately. It also allows non-radioactive substances to be assessed. Optionally, the operator interaction system is configured to receive the UV detection signal and generate a UV output from the operator based on the UV detection signal. Optionally, the control unit is configured to receive the UV detection signal. Optionally, the control unit is configured to control the collection valve system based on the UV detection signal. For example, based on the UV detection signal, possibly in combination with the radiodetection signal, the operator and/or the control unit can control the collection valve system to guide the fraction to one of the collection vessel outlets or the waste outlet.

In some embodiments, the collection system comprises or can be connected to a reformulation system for reformulating the fraction into an injectable radiopharmaceutical. Usually, the fraction collected in the separation system cannot be injected into a human in this form. Therefore, it can be reformulated. The reformulation can for example comprise diluting the fraction, for example using water or a biocompatible aqueous buffer such as saline.

In some embodiments, the collection system further comprises a cleaning valve configured to be in fluid communication with a cleaning solvent source in order to introduce a cleaning solvent into the collection system, wherein the control unit is configured to control the cleaning valve. The cleaning solvent can be used to clean the collection system, for example between different samples provided to the separation system. The cleaning solvent source can for example be a cleaning solvent reservoir or a cleaning solvent container. The cleaning solvent can for example comprise water, ethanol, or isopropanol.

In some embodiments, the collection valve system comprises a single valve. For example, the valve can have a valve inlet for receiving the fraction. This valve inlet can for example be in fluid communication with the collection inlet and/or to a back pressure regulator when SFC is used. The valve can further have at least the waste outlet and the outlet to a collection vessel in order to guide the fraction to a collection vessel. The valve can for example be a switching valve. The valve can for example be a 4-port valve, a 6-port valve, or an 8-port valve.

In some embodiments, the collection valve system comprises a first valve and a second valve, wherein the first valve comprises at least one outlet in fluid communication with a valve inlet of the second valve, wherein the second valve comprises one or more collection vessel outlets. Optionally, the second valve comprises two or more collection valve outlets. Optionally, the first valve comprises the waste outlet. For example, the first valve can have a valve inlet for receiving the fraction. This valve inlet can for example be in fluid communication with the collection inlet and/or to a back pressure regulator when SFC is used. For example, the first and second valves can be switching valves. For example, the first and second valves can be 4-port valves, 6-port valves, or 8-port valves. Some embodiments comprising the first and second valves can be particularly advantageous when a plurality of fractions are to be collected, as more collection vessel outlets can be provided, each of which can be connected to a different collection vessel.

In some embodiments, the collection system further comprises a separation system. The separation system can correspond to one of the embodiments explained herein. Generally, the separation system is configured to receive a sample comprising a plurality of substances and is configured to divide this sample into different fractions having said substances in different relative amounts. For example, the separation system can be a chromatography system, for example comprising a chromatography column. For example, the separation system can be a high-performance liquid chromatography system. For example, the separation system can be a supercritical fluid chromatography system. For example, the separation system can be configured to add a mobile phase to the sample. The mobile phase can, for example, comprise a compressed gas near, around or above its critical temperature and pressure. In practice, it has been found that advantageous results can be obtained even if the compressed gas is below but close to its critical temperature, for example by a few degrees Celsius. Said compressed gas can, for example, be carbon dioxide or nitrous oxide. Carbon dioxide is preferred. The mobile phase can also comprise a modifier, for example to modify the polarity or strength of the supercritical fluid. The modifier can for example be methanol or ethanol. In particular, the use of ethanol as a modifier is advantageous. Indeed, it can reduce the time required for reformulation, since the fraction should now only be diluted with a biocompatible aqueous solution.

In some embodiments, the collection system comprises a housing. Optionally, one or more of the following elements are arranged in the housing: the collection valve system; the radio detector; the detection enhancer; injection valve. Optionally, a collection vessel and the gas/liquid separation unit are arranged outside the housing.

The invention further relates to a method for recovering a separated radioactive fraction. Although the method can be carried out with the collection system according to the invention; neither the collection system nor the method are limited thereto. The features explained here with reference to the collection system have the same meaning with regard to the method, unless explicitly defined otherwise. The features explained with reference to the collection system can be applied mutatis mutandis to the method to obtain similar advantages.

In the embodiments, the object of the invention is a method for recovering a separated radioactive fraction, comprising the step of using a collection system according to any of the embodiments explained herein.

In some embodiments, the object of the invention is a method for recovering a separated radioactive fraction, comprising the steps of:
receiving a fraction from a separation system;
determining the radioactivity of the fraction;
controlling a collection valve system based on the determined radioactivity to guide the fraction to one or more outlets to a collection vessel or a waste outlet.

Optionally, the method is performed using a collection system according to one of the embodiments explained herein. Optionally, the separation system is a chromatography system, for example comprising a chromatography column. The chromatography system can for example be a high-performance liquid chromatography system or a supercritical fluid chromatography system.

In some embodiments, the step of controlling the collection valve system is performed by a control unit, wherein the control unit receives a radiodetection signal based on the determined radioactivity.

In some embodiments, the method comprises a step of providing an operator output to an operator, wherein the output for the operator is based on the determined radioactivity, wherein the step of controlling the collection valve system is performed based on an operator input.

In some embodiments, the method further comprises providing a sample comprising a plurality of substances to the separation system, wherein the separation system is a supercritical fluid chromatography system. The separation system can for example comprise a chromatography column. Potentially, the sample comprises at least one radioactive substance and a mobile phase. The mobile phase can for example be a supercritical fluid, for example a compressed gas near, around or above its critical temperature and pressure, such as carbon dioxide or nitrous oxide.

Carbon dioxide is preferred. The mobile phase can also comprise a modifier, for example to modify the polarity or strength of the supercritical fluid. The modifier can for example be methanol or ethanol. The method can further comprise the step of subjecting the sample to chromatographic separation in the separation system, wherein the fraction is separated from the sample at least before the radioactivity is determined. During said chromatographic separation, the sample having a plurality of substances can be divided into different fractions having said substances in different relative amounts. The method can further comprise the step of separating gas from liquid in the fraction in a gas/liquid separation unit, said gas/liquid separation unit can, for example, be a cyclone.

In some embodiments, the method further comprises a step of guiding the fraction into a collection vessel. The collection vessel can be in fluid communication with one of the collection vessel outlets of the collection valve system. When the collection valve system comprises more than one collection vessel outlet, each of these collection vessel outlets can be in fluid communication with another collection vessel. The collection valve system can be controlled to guide the fraction to an appropriate collection vessel based on the determined radioactivity. Optionally, the step of separating gas from liquid in the fraction in a gas/liquid separation unit is performed after the fraction leaves the collection valve system and before or while the fraction enters the collection vessel.

In some embodiments, the method further comprises a step to determine a UV value of the fraction and to control the collection valve system based on the determined UV value. For example, the collection valve system can be controlled to guide the fraction to an appropriate collection vessel or waste outlet based on the determined UV value, for example in addition to the determined radioactivity.

In the embodiments, the method further comprises a reformulation step, wherein the fraction is reformulated into an injectable radiopharmaceutical.

In some embodiments, the method further comprises a cleaning step. The cleaning step can for example comprise: opening a cleaning valve; allowing a cleaning solvent to enter the system through the cleaning valve; controlling the collection valve system to open the waste outlet; allowing the cleaning solvent to flow out of the collection system through the waste outlet, for example to a waste container.

The invention further provides computer-readable instructions configured to, when executed, cause a control unit of a collection system to perform the method according to any of the embodiments described herein. The collection system can for example correspond to one of the embodiments described herein.

Exemplary embodiments of the invention are described with reference to the figures. It should be understood that these figures serve only as examples of how the invention can be implemented and are in no way intended to be construed as limiting the scope of the invention and the claims. Similar features are indicated by similar reference numbers throughout the figures. In the figures:

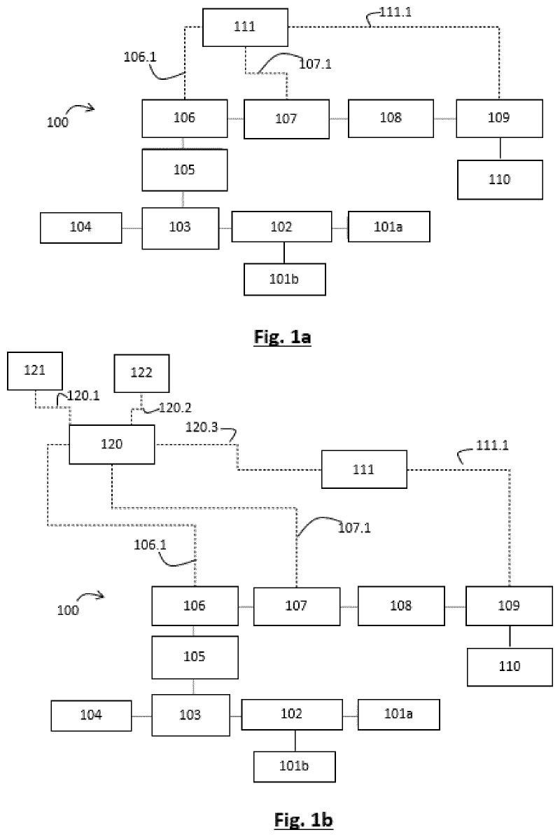

FIG. 1a: schematically shows a process for producing a pharmaceutical product;

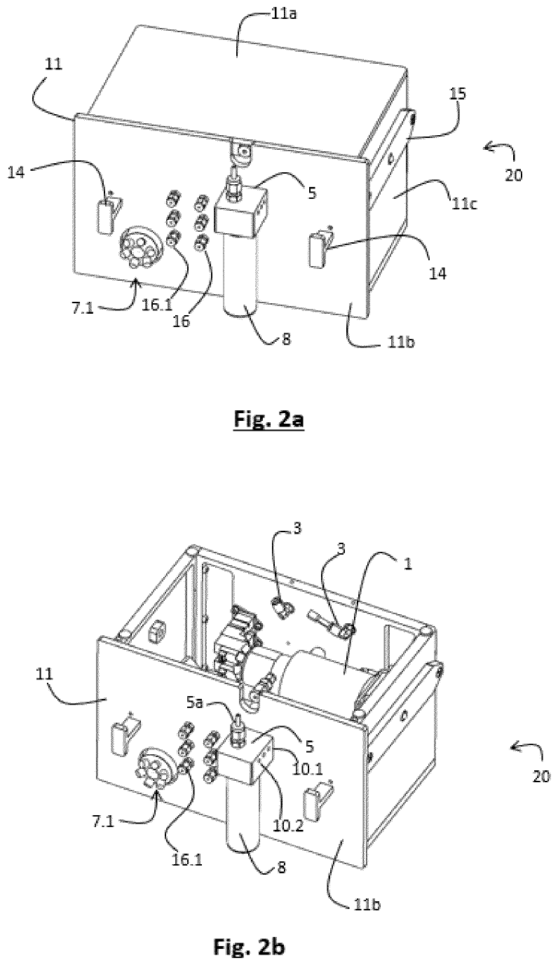

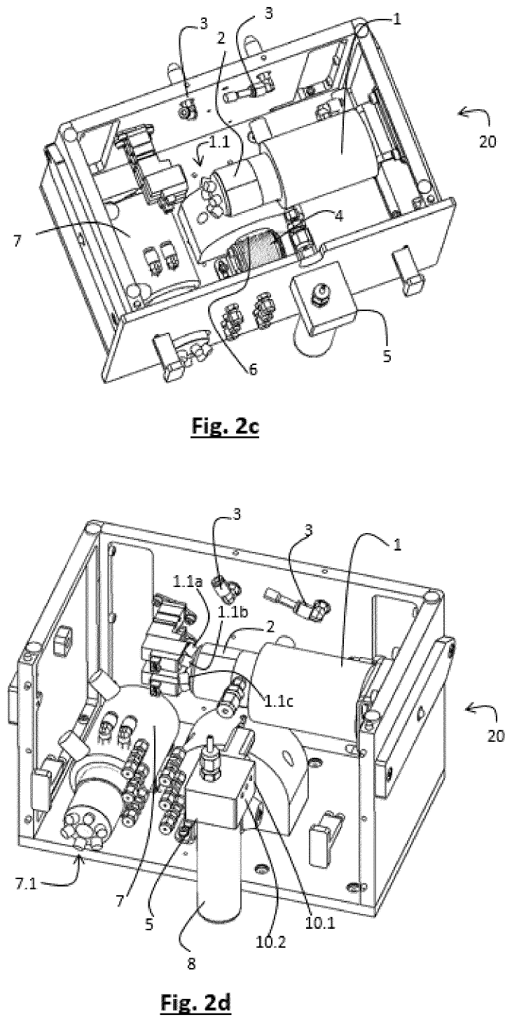

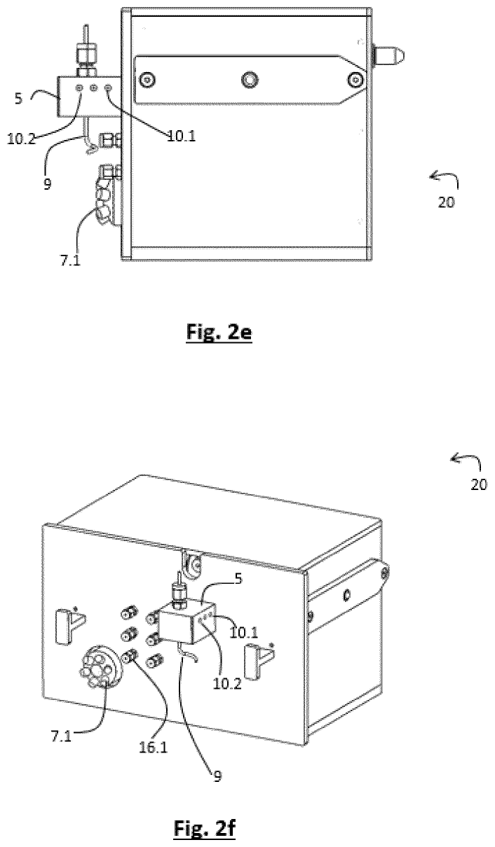

FIG. 2a: schematically shows the exterior of a collection system;

FIG. 2b-2c: schematically shows the collection system of FIG. 2a, wherein a wall is omitted for illustration purposes;

FIG. 2d: schematically shows the collection system of FIG. 2a-2c, wherein a wall is also omitted for illustration purposes;

FIG. 2e-2f: schematically shows the collection system of FIG. 2a-2d, wherein a collection vessel is omitted for illustration purposes;

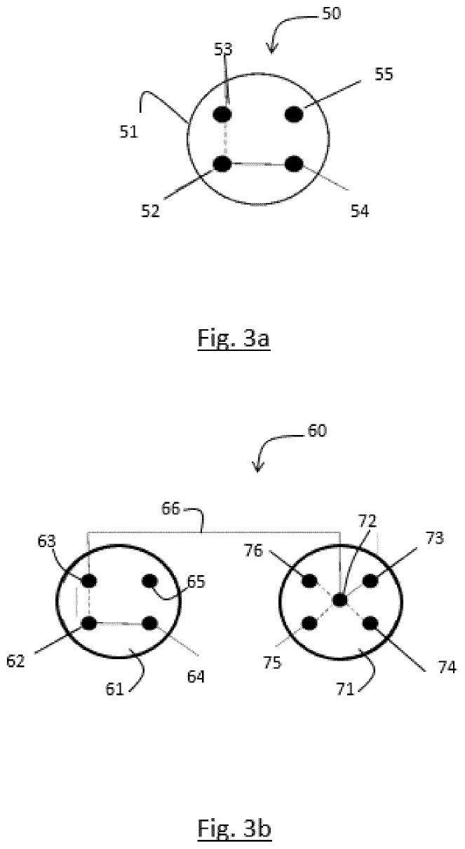

FIG. 3a: schematically shows a collection valve system comprising a single valve;

FIG. 3b: schematically shows a collection valve system having a first valve and a second valve.

FIG. 1 a schematically shows a method 100 for purifying a radiopharmaceutical. The injection valve 102 is connected to a modifier source 101a and an initial sample source 101b. From the modifier source 101a a modifier can be provided, said modifier comprising for example ethanol or methanol. From the initial sample source 101b an initial sample can be provided. This initial sample can comprise at least one radioactive substance for use in the radiopharmaceutical, for example as a PET label. Said initial sample may have been previously created in a preparatory reaction (not shown) to produce the radioactive substance. The aim of the method 100 is to obtain the radioactive substance with sufficient radiopurity and chemical purity from said sample, and to reformulate it into an injectable radiopharmaceutical.

The injection valve 102 guides the modifier and the sample to a mixing chamber 103, which is also connected to a supercritical fluid source 104 to provide a supercritical fluid, in this case carbon dioxide. In the mixing chamber 102, a sample comprising the initial sample, the modifier and the supercritical fluid is created. The supercritical fluid and the modifier together form a mobile phase.

The sample is then provided to a separation apparatus 105. In this case, the separation apparatus is a supercritical fluid chromatography system with a chromatography column. However, other separation systems can also be used, for example a high-pressure liquid chromatography system. In the separation apparatus, the sample comprising a plurality of substances undergoes a process which divides this sample into different fractions having said substances in different relative amounts. Usually, these different fractions stay in the chromatography column for different durations.

When a fraction leaves the separation apparatus 105, a UV detector determines the UV value of said fraction. The UV detector 106 generates a UV detection signal 106.1 on this basis, which is transmitted to a control unit 111, for example via an output terminal of the UV detector 106 to an input terminal of the control unit 111.

Then, a radio detector 107 determines the radioactivity of the fraction. On this basis, the radio detector 107 generates a radio detection signal 107.1 which is transmitted to the control unit 111, for example via an output terminal of the radio detector 107 to an input terminal of the control unit 111. The radio detector 107 can for example be a gamma detector.

A back pressure regulator 108 is arranged behind the radio detector 107. The back pressure regulator 108 is particularly advantageous when the separation apparatus is a supercritical fluid chromatography system, since the pressure upstream of the back pressure regulator 108 is high to ensure the supercritical state, while downstream of the back pressure regulator 108 the pressure can be lowered. The back pressure regulator 108 is configured to ensure the pressure difference is maintained.

Downstream of the back pressure regulator 108, the fraction enters a collection module 109. The collection module 109 is controlled by the control unit 111 by means of a control signal 111.1, which can in particular be configured to control a collection valve system of the collection module 109. For example, the control signal 111.1 can be sent from an output terminal of the control unit 111 to an input terminal of the collection module 109 or the collection valve system. In the collection module 109, the fraction is collected in one or more collection vessels or in a waste container. The manner in which the fraction is collected is based on the UV detection signal 106.1 and the radiodetection signal 107.1.

One or more fractions comprising a sufficient amount of the radioactive substance to be used as a radiopharmaceutical are reformulated by a reformulation system 109 in the radiopharmaceutical. The reformulation system 109 is configured to transform the fraction into an injectable solution, for example by diluting it.

It is noted that the term “collection system” as used herein can for example be reflected in the collection module 109, but can also include one or more of the other components schematically illustrated in FIG. 1a.

It is noted that FIG. 1a shows only one example, but other embodiments are also possible. For example, mixed flow injection can also be applied. For example, the supercritical fluid source 104 for providing the supercritical fluid can also be connected to the injection valve 102, wherein the injection valve 102 can be directly connected to the separation apparatus 105.

FIG. 1b shows a second embodiment of the method 100 for purifying a radiopharmaceutical. The difference with the process illustrated in FIG. 1a, is that in FIG. 1b an operator interaction system 120 is present. The operator interaction system 120 receives the radiodetection signal 107.1 and the UV detection signal 106.1. In this example, the operator interaction system 120 is directly in contact with the radio detector 107 and the UV detector 106, but it is also possible for the control unit 111 to receive the radio detection signal 107.1 and the UV detection signal 106.1 and then communicate this information to the operator interaction system 120.

The operator interaction system 120 generates an operator output 120.1 that is made visible to an operator via a display 121. The operator can determine based on the operator output 120.1 whether or not the radioactivity and/or UV value are within the desired specifications. When they are, the operator can provide an operator input 120.2, for example via a keypad 122 or a touchscreen. The operator interaction system 120 generates an operator control signal 120.3 based on the operator input 120.2. The operator control signal 120.3 is transmitted to the control unit 111, which controls the collection module 109 based on said operator control signal 120.3.

FIGS. 2a-2f illustrate a possible embodiment of a collection system 20 according to the invention. FIG. 2a shows the outside of the collection system 20, while in FIGS. 2b-2f several components have been omitted from the figures to illustrate internal features that would not otherwise be visible. A housing 11 is provided for organising several components of the collection system 20. The housing 11 can be arranged in a hot cell.

FIG. 2a illustrates a top wall 11a, a front wall 11b, and a side wall 11c of the housing 11. First fasteners 14 are provided on the front wall 11b, and a second fastener 15 is provided on the side wall 11c. The first and second fasteners 14, 15 allow the collection system 50 to be physically organised in a desired location, such as a hot cell.

FIG. 2a illustrates a plurality of connection elements 16 that allow for connection to a collection valve within the housing 11, for example to provide a separate fraction, a cleaning solvent, etc.

In FIGS. 2b and 2c, the top wall 11a of the housing 11 has been removed from the figure, and in FIG. 2d, the front wall 11b has been removed as well, to make the components within the housing 11 visible.

In the illustrated embodiment, an injection valve 7 is also provided in the housing 11. The injection valve 7 is a switching valve that has a plurality of ports 7.1 to allow for different connections between the inlets and outlets. This results in a sample having a plurality of substances, a modifier and a supercritical fluid being provided to a mixing chamber (not shown) for mixing. At least one of said substances in the sample is a radioactive substance that is intended to be used in a radiopharmaceutical. As can be seen in FIG. 2a, the ports 7.1 extend outside the housing 11. This results in the sample, modifier and supercritical fluid being provided to the injection valve 7 from outside the housing 11.

After leaving said mixing chamber, the sample is provided to a separation system (not shown), which in this case is a supercritical fluid chromatography system. In said separation system, the sample is divided into fractions that leave the separation system at different times. After potentially first passing a UV detector (not shown), one fraction is guided to the housing 11 via a collection inlet 16.1.

FIG. 2c further shows a radio detector 6. The radio detector 6 is configured to determine the radioactivity of the fraction. In this case, the radio detector 6 is capable of measuring y emissions. Based on the determined radioactivity, the radio detector 6 generates a radio detection signal which is transmitted to a control unit (not shown).

Optionally, a stainless steel loop 4 can be placed in front of the radio detector 6. It has been found that this improves the sensitivity of the radio detector 6.

Then, the fraction can then be guided out of the housing 11 again, for example via one of the connection elements 16, to go through a back pressure regulator (not shown). Since the fraction has been separated using SFC, it is at a relatively high pressure. By using the back pressure regulator, the pressure can be reduced downstream of the back pressure regulator while maintaining a high pressure upstream thereof.

The fraction is then guided to a collection valve system 1 in the housing 11 via one of the connection elements 16. The collection valve system 1 is a switching valve that has a plurality of ports 1.1. One of these ports 1.1 is a collection valve inlet 1.1a that is in fluid communication with the collection inlet 16.1, in this case via intermediate components such as the back pressure regulator. The other ports 1.1 comprise at least one waste outlet 1.1b and one or more outlets to a collection vessel 11c. The collection valve system 1 is controlled by the control unit, which is configured to guide the fraction to one of the one or more outlets to a collection vessel 1.1c and the waste outlet 1.1b, based on the measurement of the radio detector 6 and/or the UV detector. The control unit can for example do this automatically or based on the operator control signal.

In the illustrated embodiment, an optional heating sleeve 2 is provided on a part of the collection valve 1. When rapid adiabatic decompression of carbon dioxide occurs downstream of the back pressure regulator, the temperature can drop locally, for example below −70° C. This could lead to the formation of dry ice, for example in the collection valve system. The heating foil 2 compensates for the temperature drop.

FIG. 2a-2f further illustrates a collection vessel 8. The collection vessel 8 is in fluid communication with the collection vessel outlet 1.1c of the collection valve system 1. When the control unit determines that the fraction is to be collected, the collection valve system 1 is controlled in such a way that said fraction is guided to the collection vessel 8 via the outlet to a collection vessel 1.1c. In the embodiment shown, the collection vessel 8 has a cap 5 that comprises PEEK.

In FIG. 2e-2f, the collection vessel is omitted from the figure. This makes visible the presence of a gas/liquid separation unit 9a at the inlet of the collection vessel 8, which in this case is a cyclone 9. This can be advantageous in particular when a supercritical fluid chromatography system is used as the separation system. Usually, a mobile phase is used in the supercritical state when separating such a system. The mobile phase can for example comprise a supercritical fluid and a modifier. Once the fraction passes the back pressure regulator, the pressure is reduced and the supercritical fluid, in this example carbon dioxide, converts to the gaseous state. By applying a gas/liquid separation unit 9, the gaseous carbon dioxide can be removed from the fraction. The fraction collected in the collection vessel 8 therefore comprises a higher portion of the radioactive substance. Furthermore, this allows for a faster reformulation in an injectable radiopharmaceutical, since the carbon dioxide no longer needs to be removed. This reformulation can be even faster if ethanol is used as a modifier of the mobile phase.

It can be seen that the collection vessel 8 is arranged outside the housing 11. This advantageously allows for a visual inspection, for example through the window of the hot cell if the collection system is used in a hot cell. It also allows the collection vessel 8 to be replaced with a new one during the cleaning operation.

In the illustrated embodiment, the collection vessel 8 comprises at least a first outlet 10.1 and a second outlet 10.2, in this case in the head 5. The first outlet 10.1 can for example be used as an exhaust gas for the separated gas in a gas/liquid separator. The second outlet 10.2 can for example be used to connect the collection vessel 8 to a reformulation system for reformulating the fraction into an injectable solution.

FIG. 2b-2d further show the valves 3. The valves 3 are connected to a pneumatic circuit in order to operate the switching valves, for example in the collection valve system 1 and the injection valve 7.

FIG. 3a schematically shows a first possible embodiment of a collection valve system 50. In this embodiment, the collection valve system 50 comprises a single valve, indicated as valve 51. Valve 51 is a switching valve that has a valve inlet 52, an outlet to a collection vessel 53, and a waste outlet 54. In this example, valve 50 is a 4-port valve further having a fourth port 55 that is not used. Valve inlet 52 is in fluid communication with the collection inlet via a back pressure regulator and is configured to receive the fraction. The outlet to a collection vessel 53 is fluidly connected to the collection vessel. The waste outlet 54 is fluidly connected to a waste container. The illustrated embodiment can be suitable if only one collection vessel is to be filled, for example when there is only one type of fraction to be collected.

FIG. 3b schematically shows a second possible embodiment of a collection valve system 60. In this example, the collection valve system 60 comprises a first valve 61 and a second valve 71. The first valve 61 is a 4-port switching valve having a valve inlet 62. The valve inlet 62 is fluidly connected to the collection inlet via a back pressure regulator and is configured to receive the fraction. The first valve 61 further comprises a waste outlet 64 that is fluidly collected in a waste container and a fourth port 65 which is not used in the illustrated embodiment. The first valve 61 further comprises a valve outlet 63 which is fluidly connected to an inlet 72 of the second valve 71 by means of a connection 66.

In this embodiment, the second valve 71 is a 5-port switching valve and comprises 4 outlets: an outlet to a first collection vessel 73 fluidly connected to a first collection vessel; a second outlet to a collection vessel 74 fluidly connected to a second collection vessel; a third outlet to a collection vessel 75 fluidly connected to a third collection vessel; and a fourth outlet to a collection vessel 76 fluidly connected to a fourth collection vessel. The embodiment shown therefore allows the fractions to be collected in four different collection vessels. It will be understood, however, that depending on the number of different fractions to be collected, different configurations are possible. For example, the second valve 71 can comprise more outlets to a collection vessel and/or the collection valve system can comprise more valves.

Where appropriate, detailed embodiments of the present invention are described herein; however, it should be understood that the disclosed embodiments are merely examples of the invention, which can be incorporated in various ways. Therefore, the specific structural and functional details disclosed herein should not be interpreted as limiting, but merely as a basis for the claims and as a representative basis for teaching those skilled in the art to implement the present invention in various manners in virtually any suitable detailed structure. Not all of the objects described need be achieved with particular embodiments.

Furthermore, the terms and expressions used herein are not intended to limit the invention, but to provide a comprehensible description of the invention. The words “a” or “an” used herein mean one or more, unless otherwise indicated. The terms “a multiple of”, “a plurality” or“several” mean two or more than two. The words “comprise”, “include”, “contain” and “have” have an open meaning and do not exclude the presence of additional elements. The reference numbers in the claims should not be interpreted as limiting the invention.

The mere fact that certain technical features are described in different dependent claims always allows for the possibility that a combination of these technical measures can be used advantageously.

A single processor or other unit can perform the functions of various components mentioned in the description and claims, for example processing units or control units, or the functionality of a single processing unit or control unit described herein can in practice be distributed over several components, possibly physically separated from each other. Any communication between components can be wired or wireless using known methods.

The actions performed by the control unit can be implemented in the form of a program, for example a computer program, a software application or the like. The program can be executed using computer-readable instructions. The program can include a subroutine, function, procedure, object method, object implementation, executable application, source code, object code, shared library/dynamic load library, and/or other set of instructions designed to be executed on a computer system.

A computer program or computer-readable instructions can be stored and/or distributed on a suitable medium, such as an optical storage medium or a solid-state medium provided with or as part of other hardware, but can also be distributed in other forms, such as via the Internet or other wired or wireless telecommunications systems.

1. A collection system comprising:
a collection inlet configured to receive a fraction from a separation system,
a radio detector configured to determine a radioactivity of the fraction and to generate a radiodetection signal based on the radioactivity of the fraction,
a collection valve system in fluid communication with the collection inlet, wherein the collection valve system comprises an at least one outlet to a collection vessel and a waste outlet, and
a control unit configured to control the collection valve system to guide the fraction to the at least one outlet to a collection vessel or to the waste outlet,
the collection system being for recovering a separated radioactive fraction.

2. The collection system according to claim 1, further comprising the separation system, wherein said separation system is a supercritical fluid chromatography system, wherein the collection system further comprises:
a back pressure regulator between the separation system and the collection valve system, and
a gas/liquid separation unit, wherein the gas/liquid separation unit is configured to separate a gas from a fluid of the fraction after the fraction exits the collection valve system.

3. (canceled)

4. The collection system according to claim 1, wherein the control unit is configured to receive the radiodetection signal from the radio detector, and control the collection valve system based on the radiodetection signal.

5. The collection system according to claim 1, further comprising an operator interaction system configured to:
receive the radiodetection signal and generate an output for an operator based on the radiodetection signal, and
receive an operator input and generate an operator control signal based on the operator input,
wherein the control unit is configured to control the collection valve system based on the operator control signal.

6. The collection system according to claim 1, further comprising at least one first collection vessel in fluid communication with a first outlet to a collection vessel of the collection valve system.

7. The collection system according to claim 1, further comprising a detection enhancer for the radio detector.

8. The collection system according to claim 1, further comprising a UV detector configured to determine a UV value of the fraction and to generate a UV detection signal based on the UV value of the fraction.

9. The collection system according to claim 1, further comprising a reformulation system configured to reformulate the fraction in an injectable radiopharmaceutical.

10. The collection system according to claim 1, further comprising a diluent valve in fluid communication with a diluent source configured to introduce diluent into the collection system, wherein the control unit is configured to control the diluent valve to dilute the fraction.

11. The collection system according to claim 1, further comprising a cleaning valve in fluid communication with a cleaning solvent source configured to introduce a cleaning solvent into the collection system, wherein the control unit is configured to control the cleaning valve.

12. The collection system according to claim 1, wherein the collection valve system comprises a first valve and a second valve, wherein the first valve comprises at least one outlet in fluid communication with an inlet of the second valve, wherein the second valve comprises at least one outlet to the collection vessel.

13. A method of recovering a separated radioactive fraction, the method comprising using the collection system according to claim 1.

14. A method comprising:
receiving a fraction from a separation system;
determining a radioactivity of the fraction; and
controlling a collection valve system based on the radioactivity of the fraction to guide the fraction to an at least one outlet to a collection vessel or a waste outlet,
the method being a method of recovering a separated radioactive fraction.

15. The method according to the claim 14, the method further comprising:
providing a sample comprising a plurality of substances to the separation system, wherein the separation system is a supercritical fluid chromatography system, wherein the sample comprises at least one radioactive substance and one mobile phase,
subjecting the sample to chromatographic separation in the separation system, wherein the fraction is separated from the sample at least before determining the radioactivity, and
separating a gas from a liquid in the fraction in a gas/liquid separation unit.

16. The method according to claim 14, further comprising guiding the fraction into the collection vessel.

17. The method according to claim 14, further comprising determining a UV value of the fraction and controlling the collection valve system based on the deter-mined UV value of the fraction.

18. The method according to claim 14, further comprising a reformulation step, wherein the fraction is reformulated into an injectable radiopharmaceutical.

19. The method according to claim 18, wherein the fraction comprises ethanol, wherein the method further comprises in the reformulation step diluting the fraction with saline.

20. The method according to claim 14, further comprising a cleaning step comprising;
opening a cleaning valve,
allowing a cleaning solvent to enter a collection system through the cleaning valve,
controlling the collection valve system to open the waste outlet; and
allowing the cleaning solvent to flow out of the collection system through the waste outlet.

21. The method according to claim 15, further comprising executing computer readable instructions configured to cause a control unit of a collection system to perform the method according to claim 15.
